(19) United States
(12) Patent Application Publication
(10) Pub. No.: US 2009/0319235 A1
(43) Pub. Date: Dec. 24, 2009

(54) Fiberglass Cross Arm And Method Of Selecting Same

(75) Inventors: Wei-Chung Lin, Pelham Patkway, AL (US); Alan Tse, Bolingbrook, IL (US); Richard Patterson, Rock Hill, SC (US)

Correspondence Address: THE MACLEAN - FOGG COMPANY,;C/O THE ALDEN LAW GROUP, 2122 YORK ROAD, SUITE 180, OAK BROOK, IL, 60523, US

(73) Assignee: MacLean-Fogg Company, Mundelein, IL (US)

(21) Appl. No.: 12/210,325

(22) Filed: Sep. 15, 2008

Related U.S. Application Data
(60) Provisional application No. 61/045,935, filed on Apr. 17, 2008.

(51) Int. Cl. G06F 17/50; E04H 12/24

(52) U.S. Cl. 703/1; 52/40

(57) ABSTRACT

Embodiments described herein relate to a composite cross arm for use with a utility structure and a program for selecting a cross arm. The cross arm includes a composite member, a hardware plate, and a mounting bracket. The program includes a data subroutine where the user selects the type of cross arm and inputs the required data. Thereafter, the program provides the appropriate cross-arm for the user.

### REFERENCE TO RELATED APPLICATIONS

This application is a conversion of U.S. Provisional Application No. 61/045,935 filed on Apr. 17, 2008 to a non-provisional U.S. patent application and claims benefit of that earlier filing date. That Provisional Application is incorporated herein in its entirety by this reference.

### FIELD

Embodiments described herein relate to cross arms, cross arm brackets, and programs for selecting cross arms and cross arm brackets.

### BACKGROUND

Cross arms and cross arm brackets are used by utility companies to position and support insulators and cable lines. Previously cross arms have been made of wood and steel. However, wood and steel cross arms have several disadvantages.

Over time, wood cross arms deteriorate and can rot due to weather, thereby decreasing the strength of the wooden cross arm and necessitating replacement. A wooden cross arm can absorb moisture and become a poor electrical insulator. As such, there is a risk of electricity traveling though the wooden cross arm. This can pose a risk of electrocution to a line technician. Additionally, wooden cross arms can suffer from variations in strength do to inherent flaws within the wood.

Others have proposed using steel cross arms; however, steel cross arms are insufficiently robust and end up corroding when exposed to the elements. Further, steel cross arms lack the electrical insulating properties that are desirable for electric power line applications.

Still others have used fiberglass in the construction of cross arms, such as those disclosed in U.S. Pat. No. 6,834,469. The device of U.S. Pat. No. 6,834,469 utilizes a foam filled beam having transverse and vertical holes for mounting external structures. Accordingly, the locations of the external structures are limited to the transverse and vertical holes.

U.S. Pat. No. 4,262,047 depicts a fiberglass cross arm including bores with sleeves telescoped therein. The bores are used to located the fiberglass cross arm to a support structure and to located the external structures to the cross arm. As such, the cross arm in U.S. Pat. No. 4,262,047 must be secured to a support structure via the bores, and the external structures must be located via the bores. Accordingly, there exists a need for an adjustable fiberglass cross arm that allows a technician to easily adjust the location of the cross arm relative to the support structure, and the location of the external structures.

### SUMMARY

Briefly stated, a composite cross arm described herein includes a composite member provided with a plurality of extensions. The cross arm includes an attachment assembly, a plurality of hardware plates, and clasping members. The hardware plates can be retained in sliding engagement to enable utility hardware to be placed in alignment with, for example, a utility line.

A program that analyzes a user's input to select a utility product, such as a dead end cross arm application or a tangent cross arm application. The program includes an acquisition routine, an application subroutine, a data subroutine, and calculation routine, and a report routine. In one embodiment, the program is integrated with a product purchasing program.

### BRIEF DESCRIPTION OF THE DRAWINGS

FIG. 1 depicts a cross-sectional view of one embodiment of the cross arm and the attachment assembly;

FIG. 2 depicts a perspective view of one embodiment of the cross arm;

FIG. 3 depicts a cross-sectional view of one embodiment of the hardware plates in cooperation with the cross arm;

FIG. 4 depicts a close up view of one embodiment of the internal surface of the hardware plate;

FIG. 5 depicts a close up view of one embodiment of the external surface of the hardware plate;

FIG. 6 depicts a close up view of one embodiment of the pole mount;

FIG. 7 depicts a top-down view of one embodiment of the cross arm attached to a pole;

FIG. 8 depicts a perspective view of one embodiment of the cross arm with an insulator attached thereto;

FIG. 9 depicts a perspective view of one embodiment of the cross arm with an insulator attached thereto;

FIG. 10 depicts a one embodiment of a program;

FIG. 11 depicts an application subroutine;

FIG. 12 depicts a data subroutine;

FIG. 13 depicts a data subroutine;

FIG. 14 depicts a result of the application subroutine;

FIG. 15 depicts one embodiment of the user interface of the application subroutine;

FIG. 16 depicts one embodiment of the user interface of the data subroutine;

FIG. 17 depicts one embodiment of the user interface of the calculation routine; and

FIG. 18 depicts one embodiment of the report generation.

### DETAILED DESCRIPTION

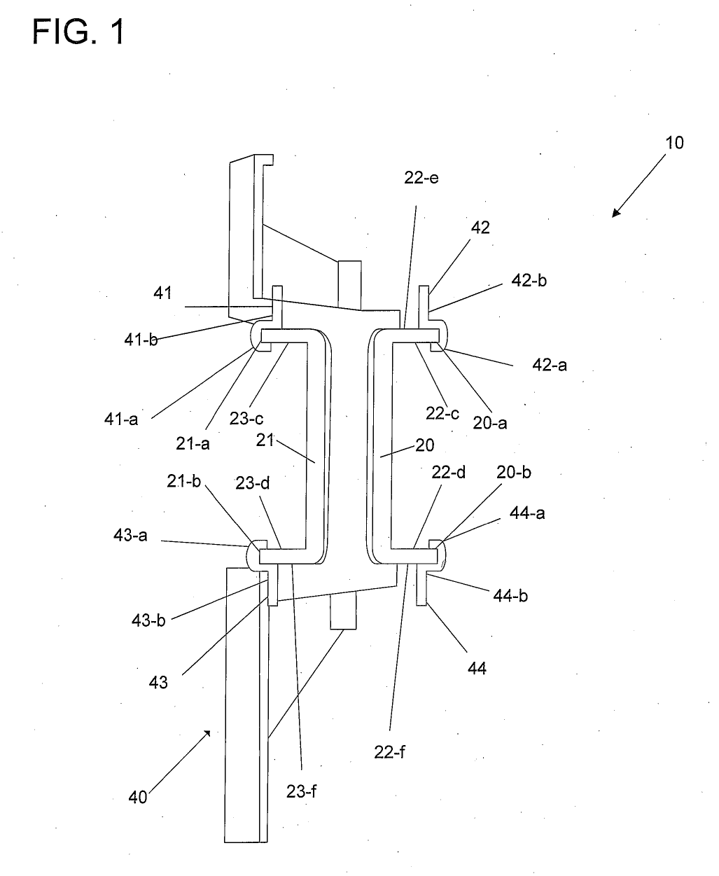

FIG. 1 depicts a cross-sectional view of a cross arm 10 constituting an embodiment described herein. As shown therein, a composite member 20 is provided. In one embodiment, a plurality of composite members 20, 21 are attached together via an attachment assembly 40, a plurality of hardware plates 71, 72, and clasping members 41, 42, 43, 44. As FIG. 1 also illustrates, the clamping force of the clasping members 41, 42, 43, 44 is distributed through the cross arm 10. However, a single composite member 20 could be used as a cross arm 10. Advantageously, each composite member 20, 21 represents the result of a single extruded tube of fiberglass being cut into identical (or substantially identical) halves. While one embodiment is a fiberglass material extruded into a tube, other materials can be employed. In an alternative embodiment, an armed fiber material is used. In yet another alternative embodiment, a polyester fiber is used.

As stated above, one embodiment is fabricated by extrusion, alternative embodiments are fabricated through other processes. In one alternative embodiment, the tube 30 is fabricated by filament winding resin impregnated fibers around an approximately shaped mandrel. In yet another alternative embodiment, the tube 30 is fabricated by rolling a plurality of sheets of pre-impregnated unidirectional material around a mandrel. While fibers can be wound (or rolled as the case may be) around a mandrel, in an alternative embodiment, a braided or triaxial sock can be slipped over a mandrel, taped, and then cured in an oven. Alternatively, the epoxy resin can be cured by exposing the material to UV light.

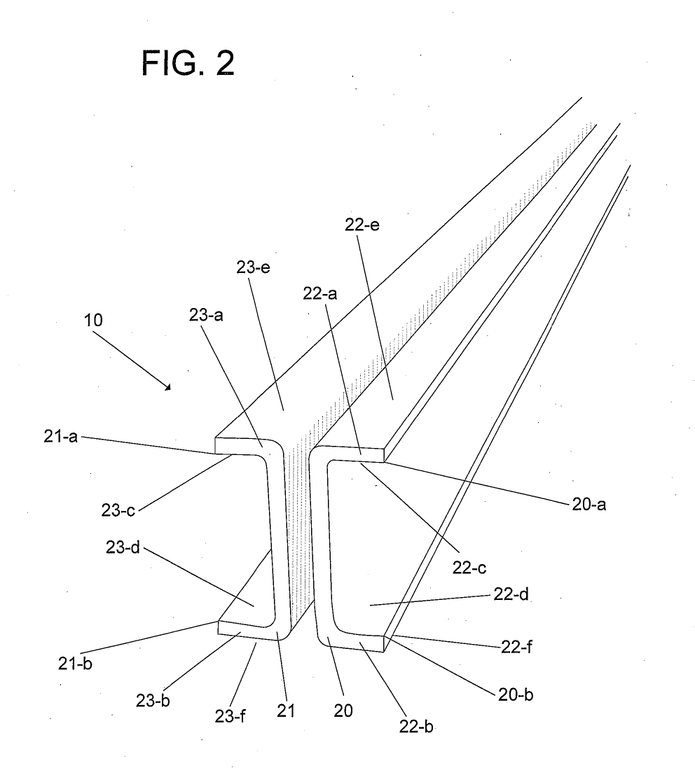

Referring now to FIG. 2, each of the composite members 20, 21 is provided with a plurality of extensions 22, 23, each of which is specifically designated 22-a, 22-b, 23-a, 23-b. Each of the extensions, 22-a, 22-b, 23-a, 23-b terminates at an edge. Thus, as shown in FIG. 1, extension 22-a terminates at edge 20-a; extension 22-b terminates at edge 20-b; extension 23-a terminates at edge 21-a, and extension 23-b terminates at edge 21-b. Each of the extensions, 22-a, 22-b, 23-a, 23-b is provided with an inner surface and an outer surface. As illustrated in FIG. 2, extension 22-a is provided with an inner surface 22-c that faces inner surface 22-d located on extension 22-b. Similarly, extension 23-a is provided with an inner surface 23-c that faces an inner surface 23-d located on extension 23-b.

FIG. 2 also illustrates each of the extensions 22-a, 22-b, 23-a, 23-b provided with outer surfaces 22-e, 22-f, 23-e, 23-f. Outer surface 22-e is, relative to inner surface 22-c, located on the opposite side of extension 22-a and faces away from inner surface 22-d. In the same vein, outer surface 22-f is, relative to inner surface 22-d, located on the opposite side of extension 22-b and faces away from inner surface 22-c. Similarly, outer surface 23-e is, relative to inner surface 23-c, located on the opposite side of extension 23-a. Lastly, outer surface 23-f is, relative to inner surface 23-d, located on the opposite side of extension 23-b.

As noted above, one embodiment uses an attachment assembly 40, a plurality of hardware plates 71, 72, and clasping members 41, 42, 43, 44 in attaching the composite members 20, 21 to the pole mount 90 or base. However, in alternative embodiments, the composite members 20, 21 are attached through the use of an adhesive. In yet another embodiment, an attachment assembly 40 is used. FIG. 2 depicts a perspective view of the composite members 20, 21 attached to each other.

The attachment assembly 40 is provided with a plurality of clasping members 41, 42, 43, 44. The clasping members 41, 42, 43, 44 are each provided with a leg and a lip. The lip corresponding to each of the clasping members 41, 42, 43, 44 has been designated accordingly (the lip of clasping member 41 has been designated 41-a and so forth). In the same vein, the leg corresponding to each of the clasping members 41, 42, 43, 44 has been designated accordingly (the leg of clasping member 41 has been designated 41-b and so forth).

As demonstrated in FIG. 1, each lip of the clasping members extends, at least in part, over each edge of the composite members 20, 21. Thus, lip 41-a extends over edge 21-a; lip 42-a extends over edge 20-a; lip 43-a extends over edge 21-b; and lip 44-a extends over edge 20-b. Advantageously, the lips 41-a, 42-a, 43-a, 44-a extend over the inner surfaces 23-c, 22-c, 23-d, 22-d, at least a portion of the composite members 20, 21. When used with the composite members 20, 21, the lip of each of the clasping members 41, 42, 43, 44 engages at least a portion of each of the composite members.

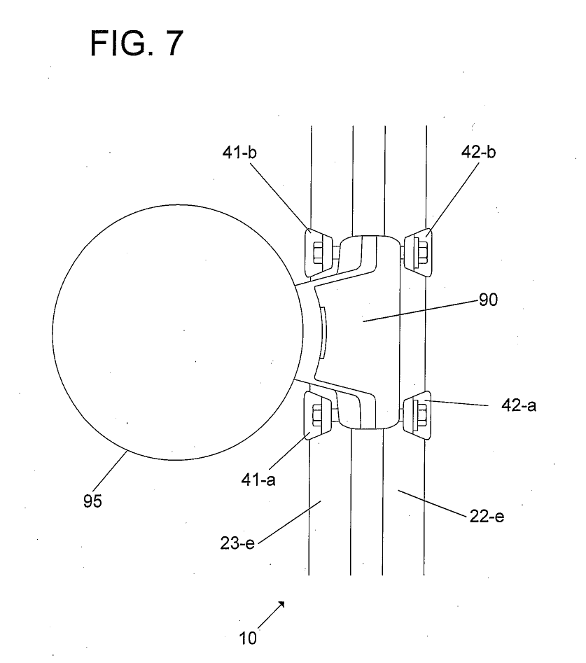

As stated above, each of the clasping members 41, 42, 43, 44 is provided with a leg. In one embodiment, the legs 41-b, 42-b, 43-b, 44-b extend from the outer surfaces 23-e, 22-e, 23-f, 22-f of the composite members. As FIG. 1 illustrates, each leg extends from each outer surface so that the leg and the corresponding outer surface are generally orthogonal, an orientation suitable for a fastener. In one embodiment, a bolt extends parallel to the outer surfaces 22-e, 23-e of the composite members 20, 21 through the respective legs 41-b, 42-b of clasping members 41, 42 (as is shown in FIG. 7). In similar fashion, a bolt extends parallel to the outer surfaces 22-f, 23-f of the composite members 20, 21 through the respective legs 43-b, 44-b of clasping members 43, 44. Thus, the clasping members 41, 42, 43, 44 secure together the two composite members 41, 42.

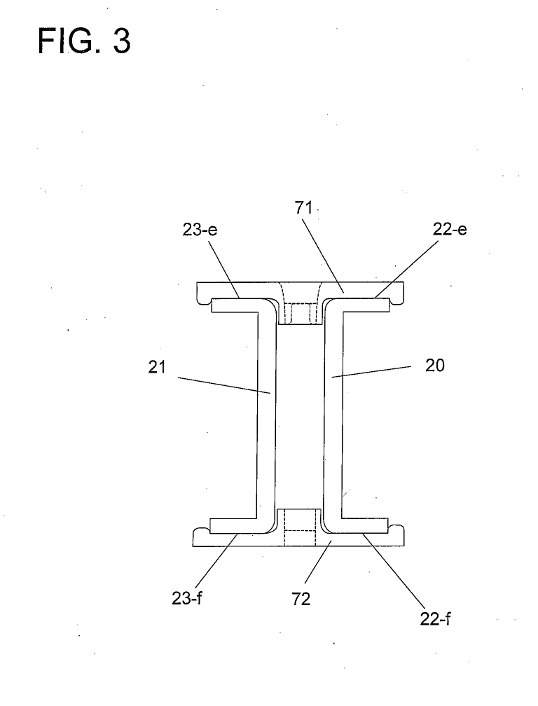

Referring now to FIG. 3, the cross arm is 10 is provided with a plurality of hardware plates 71, 72, which are referred to herein as a first plate 71 and a second plate 72. The plates 71 and 72 are made of a metallic material such as steel or aluminum; however, other materials can be used, such as wood, phenolic, or a thermoplastic. The hardware plates 71, 72 are strapped to clamp together the composite members 20, 21. As shown in FIG. 3, the first plate 71 engages the outer surfaces 23-e, 22-e of composite members 20, 21. Similarly, the second hardware plate 72 engages the outer surfaces 23-f, 22-f of the composite members 20, 21. The hardware plates 71, 72 are each provided with external and internal surfaces, which have been designated 73 and 74 respectively.

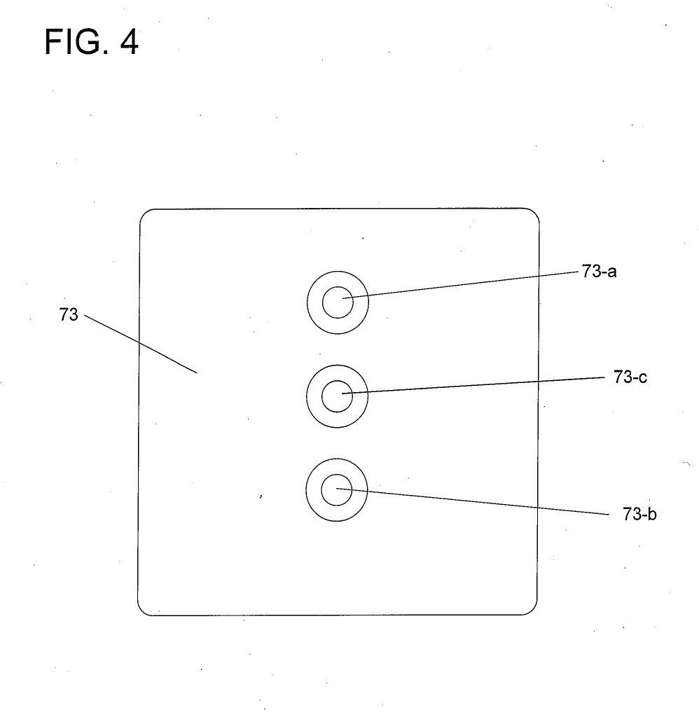

FIG. 4 depicts the external surface 73 provided with a plurality of holes 73-a, 73-b and 73-c. Holes 73-a and 73-b can be tapped so that a threaded bolt can be used to bring the plates 71 and 72 into clamping engagement with the composite members 20, 21. Alternatively, a lock washer and nut combination may be used with the threaded bolt to bring the plates 71 and 72 into clamping engagement with the composite members 20, 21.

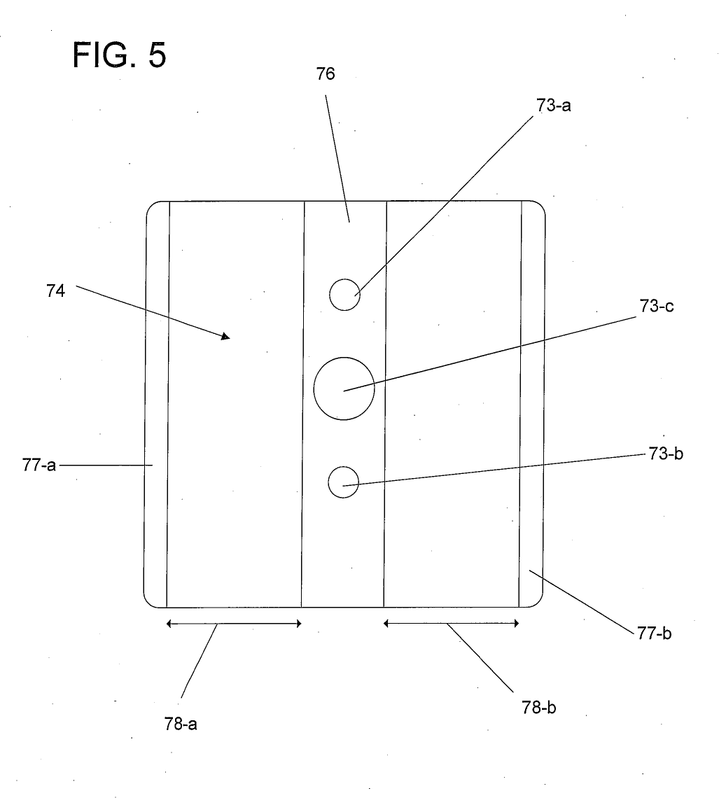

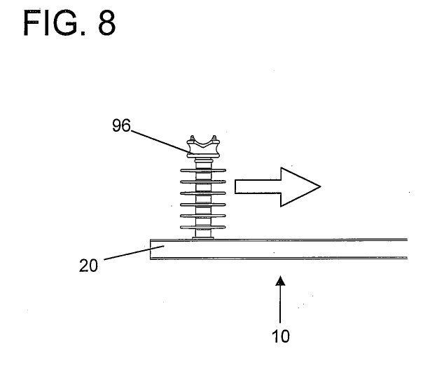

Referring now to FIG. 5, the internal surface 74 of the hardware plates 71 and 72 is shown. As illustrated therein, the internal surface is shaped according to the composite members 20 and 21. The internal surface 74 of the hardware plates 71, 72 is provided with a spacing ridge 76. The spacing ridge 76 extends down the central portion of the internal surface 74 and enables the hardware plates 71 and 72 to hold the composite members 20 and 21 in alignment, while, at the same time, providing a suitable location for a pin (not shown) for mounting an insulator (not shown) in FIG. 8, the spacing ridge 76 is provided with hole 73-c through which a pin may be placed for hardware mounting. Hole 73-c is located in the center of each of the plates 71, 72 and is so located to maximize the strength and aligning functions of the spacing ridge 76.

Opposing sides of the internal surface 74 are projections 77-a and 77-b. The projections 77-a and 77-b are located distances 78-a and 78-b which equal the width of the outer surfaces 23-e-, 22-e of the composite members 20, 21. The projections 77-a, 77-b together with the spacing ridge 76, hold the composite members 20, 21 in secure alignment.

In operation, the threaded bolts (not shown) that are passed through the tapped holes 73-a and 73-b can be loosened; thus, the hardware plates 70, 71 can be retained in sliding engagement on the composite members 20, 21. This sliding engagement enables the hardware plates to slide along the composite members 20, 21. Because electrical lines extend across the composite members 20 and 21, (as shown in FIG. 8), the sliding engagement enables hardware (such as an insulator) to be placed in alignment with the appropriate electrical line.

FIG. 8 depicts a side view of a portion of the cross arm 10 with a composite member 20 and an insulator 96 attached to the hardware plates 71, 72 via a pin through hole 73-c. As FIG. 8 illustrates, when the fasteners placed through holes 73-a and 73-b are loosened, the insulator 96 can slide along the composite member 20 and be aligned with a utility line (not shown)

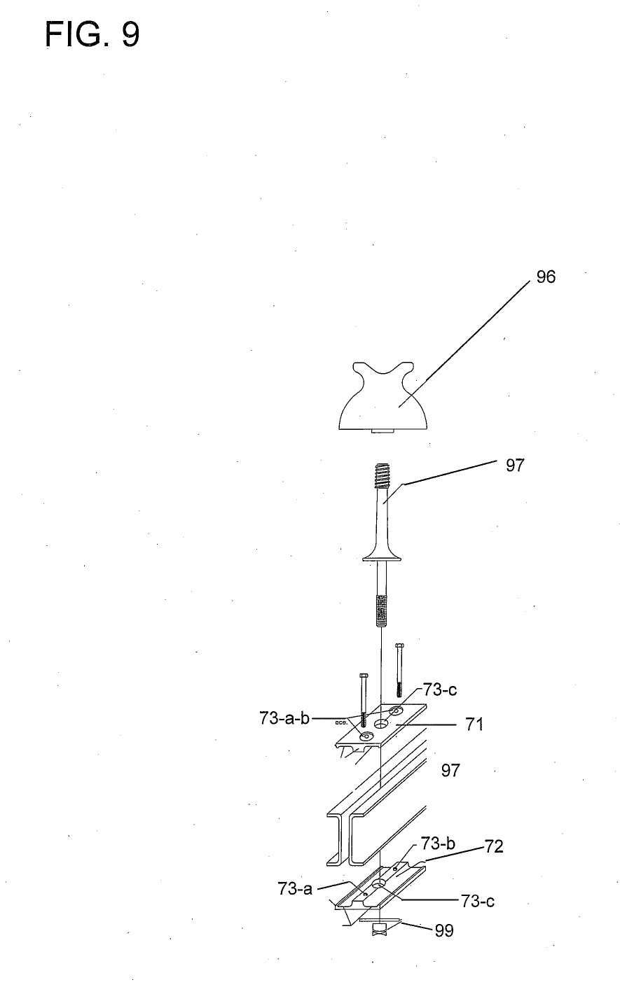

FIG. 9 depicts a side view of another embodiment of the cross arm 10 with a composite member 20 and an insulator 96 attached to the hardware plates 71, 72 via a pin 97 through hole 73-c. As FIG. 9 illustrates, when the fasteners placed through holes 73-a and 73-b are loosened, the insulator 96 can slide along the composite member 20 and be aligned with a utility line (not shown). As depicted therein, the pin 97 is secured to the cross arm by way of a fastener 99, such as a washer, nut, and nut retainer.

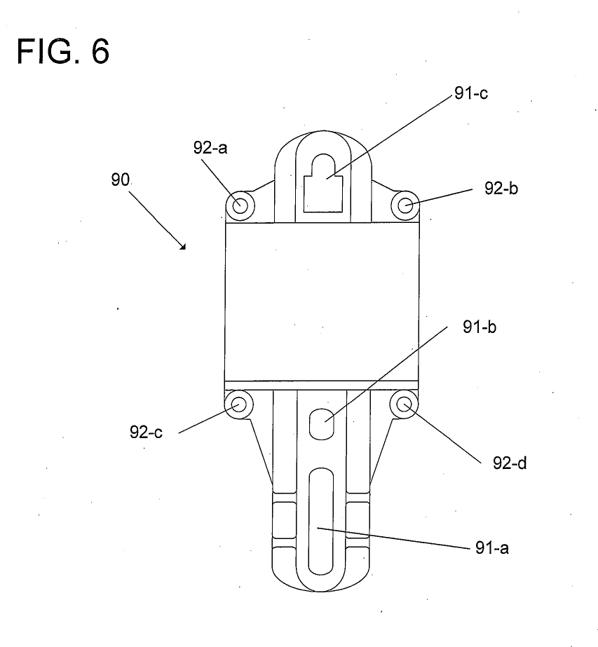

Referring now to FIG. 6, the cross arm 10 is provided with a pole mount 90. The pole mount 90 is provided with a plurality of holes. As shown in FIG. 6, the pole mount 90 is provided with a plurality of mounting holes 91-a, 91-b, 91-c. The mounting holes 91-a, 91-b, 91-c are shaped to accept a fastener, such as a bolt (not shown) with a shank and a head. The mounting holes 91-a, 91-b, 91-c accept the shank of the bolt while the head of the bolt clamps the pole mount. In an alternative embodiment, a simple washer (not shown) may also be employed. The mounting holes 91-a, 91-b, 91-c are shaped so that the pole mount can be adjusted by loosening the mounting bolts; the pole mount 90 can be moved up or down so that the cross arm 10 can be placed at the correct height.

The pole mount 90 is also provided with a plurality of clamp holes 92-a, 92-b, 92-c, and 92-d. The clamp holes 92-a, 92-b, 92-c, and 92-d are positioned to line up with holes located on the clamping members 41, 42, 43, 44. In one embodiment, the pole mount 90 is fabricated from a cast iron in a sand mold.

Referring now to FIG. 7, the cross arm 10 is shown in a top-down view attached to a pole, designated 95. As shown therein, the clasping members are shown on opposing sides of the pole mount 90. Hidden from view in FIG. 2, a second pair of clasping members is shown in FIG. 7. To distinguish one pair of clasping members from the other, the clasping members shown in FIG. 7 shall be designated 41-a, 42-a, 41-b, and 42-b. As FIG. 7 illustrates, the clasping members 41-a, 42-a, are aligned with hole 92-a in the pole mount 90. While clasping members 41-b, 42-b are aligned with hole 92-b in the pole mount 90.

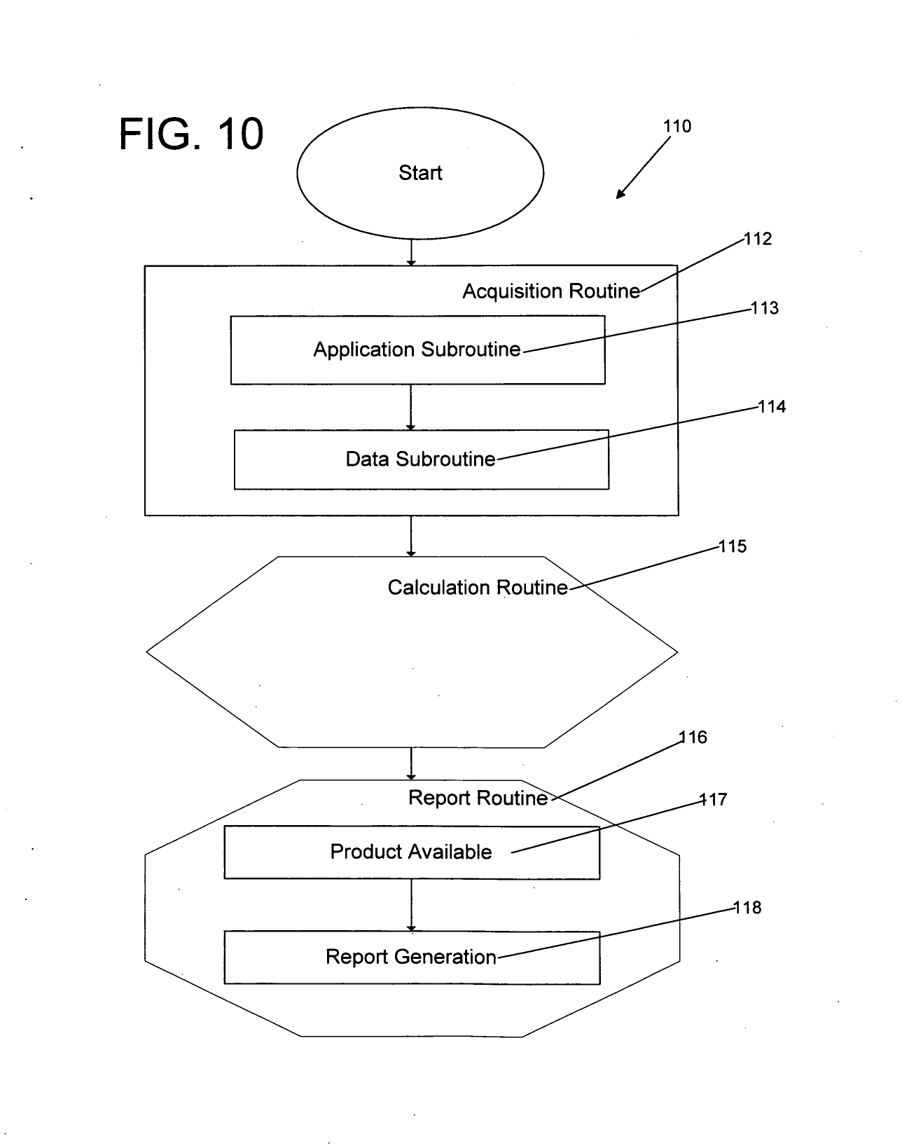

FIG. 10 depicts one embodiment of a program 110 that analyzes user input in order to select a product. Advantageously, the program 110 analyzes user input to select a utility product, such as a cross arm. While one embodiment is a program that selects a cross arm, the program 110 can be adapted to analyze user input for other types of products, such as an insulator. In one embodiment, the program 110 is software run on a computer. As shown in FIG. 10, the program 110 begins by running an acquisition routine 112 that obtains application data via an application subroutine 113. In the case of a cross arm product, the application subroutine 113 obtains user input by indicating whether the application is a cross arm application (such as when a conductor is terminated on a utility pole), also referred to herein as a “Deadend Application,” or whether the application is a tangent cross arm application (such as when a conductor extends from one cross arm to another), also referred to herein as a “Tangent Application.”

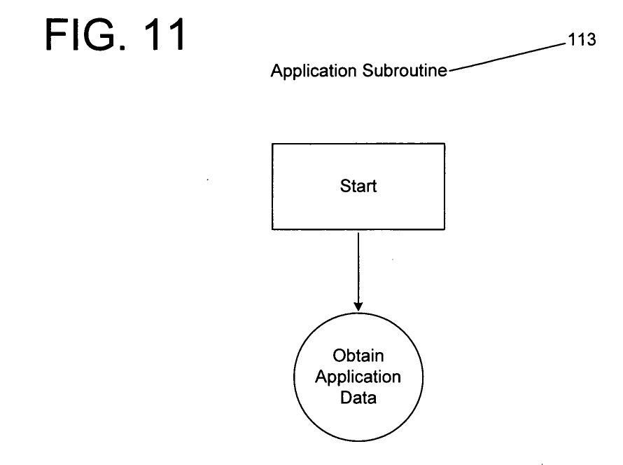

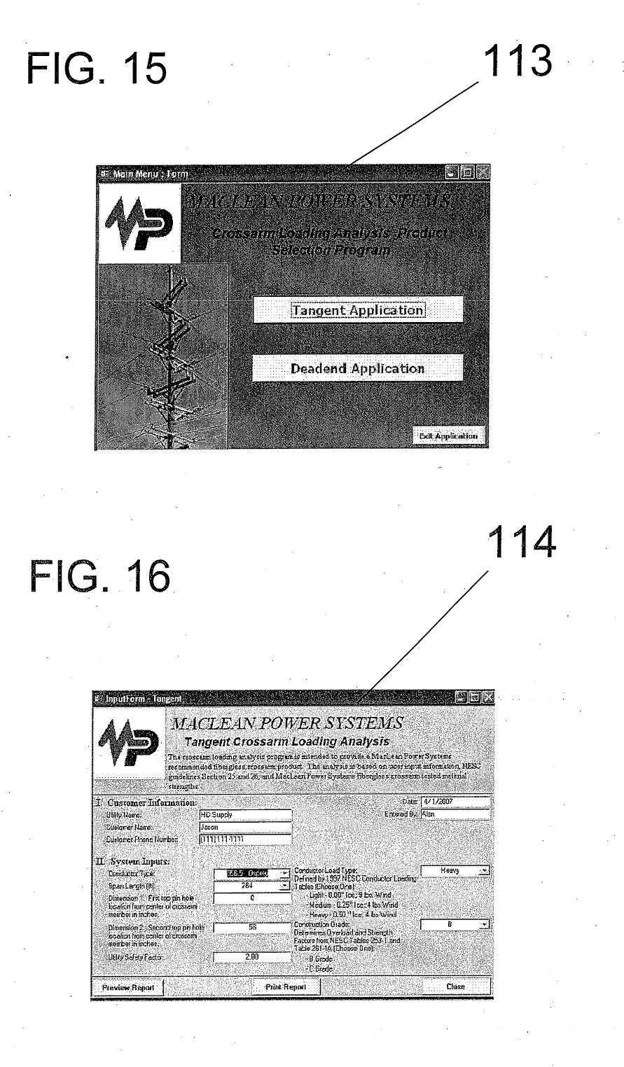

FIG. 11 depicts the application subroutine 113 obtaining application data; as shown therein, the application subroutine 113 obtains application data by prompting the user to select whether the application is a “Tangent Application” or a “Deadend Application.” FIG. 15 depicts the user interface of the application subroutine 113, wherein the user is prompted to select whether the application is a “Tangent Application” or a “Deadend Application.” As FIG. 15 also illustrates, the program 110 enables the user to exit by clicking an “Exit Application” button. After the application subroutine 113 obtains application data, the acquisition routine 112 obtains numeric data via a data subroutine 114. In the case of a utility product, the data subroutine 114 obtains user input indicating the loads that the product must withstand. After the application data has been obtained, the data subroutine 114 obtains numeric data and data relating to the loads imposed upon the product.

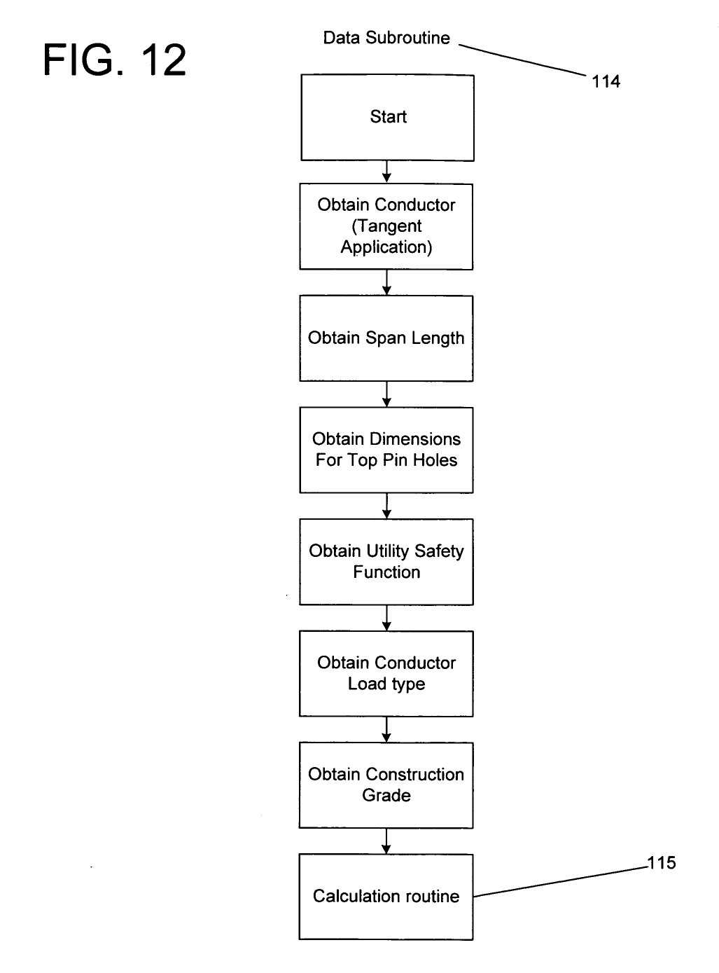

FIG. 12 involves a case in which the user has provided application data indicating that the cross arm product will be used in a “Tangent Application.” The data subroutine 114 thus prompts the user to provide the conductor type, the span length, the dimensions for pin holes, the utility safety factor, the conductor load type (such as the NESC conductor load type), and the construction grade (such as the NESC construction grade). The data subroutine 114 can prompt the user to provide the required data in any order.

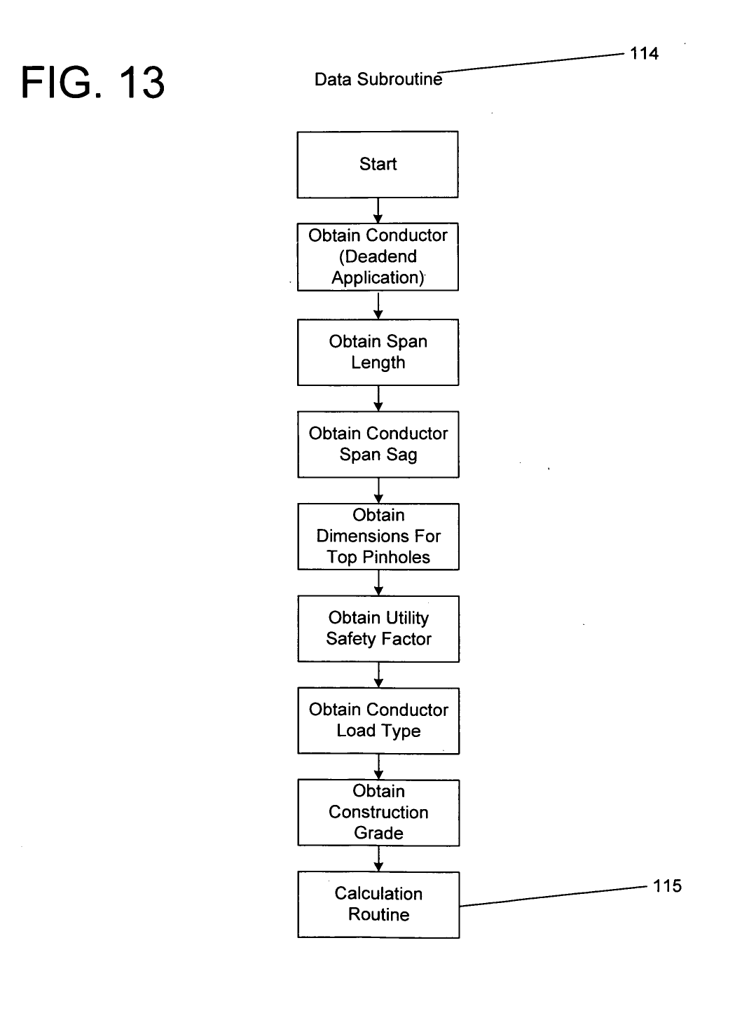

FIG. 13 involves a case in which the user has provided application data indicating that the cross arm product will be used in a “Deadend Application.” The data subroutine 114 thus prompts the user to provide the conductor type, the span length, the conductor span sag, the dimensions for pin holes, the utility safety factor, the conductor load type (such as the NESC conductor load type), and the construction grade (such as the NESC construction grade).

After the data subroutine 114 obtains the numeric data, the program 110 executes a calculation routine 115. The calculation routine 115 uses the numeric data that the data subroutine 114 has obtained as well as the application data that the application subroutine 113 has obtained and performs a plurality of mathematical operations. In the case of a utility application, the calculation routine 115 calculates the loads the product should withstand.

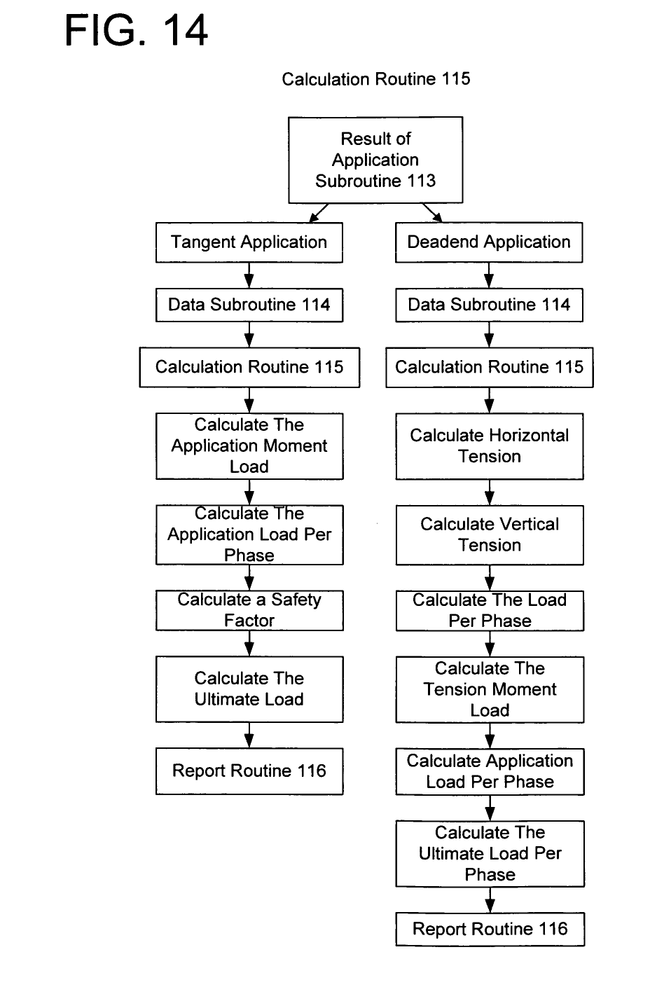

Referring now to FIG. 14, the case of a tangent cross arm application is shown. As illustrated therein, the calculation routine 115 calculates a plurality of loads. First, the calculation routine 115 uses the application data from the application subroutine 113 to determine whether the cross arm is a tangent cross arm or deadend cross arm. Then, in the case of a tangent cross arm application, the calculation routine 115 calculates the loads corresponding to a tangent cross arm product. As shown in FIG. 14, the calculation routine 115 calculates the application moment load, the application load per phase with a safety factor (both a NESC safety factor and a utility safety factor), and an ultimate load per phase. The calculation routine 115 can calculate the plurality of loads in any order,

Referring now to FIG. 14, the case of a deadend cross arm application is shown. As in the case of a tangent cross arm application, the calculation routine 115 calculates a plurality of loads and uses the application data from the application subroutine to determine whether the cross arm is a tangent cross arm or deadend cross arm. Then, after the program 110 establishes that a deadend cross arm application has been selected, the calculation routine 115 calculates the loads corresponding to a deadend cross arm application. As shown in FIG. 14, the calculation routine 115 calculates the horizontal tension, the vertical tension, the resultant tension load or load per phase, the tension moment load, the application load per phase with a safety factor (both a NESC safety factor and a utility safety factor), and an ultimate load per phase.

In one embodiment, the program 110 is available over the world wide web. In another embodiment, the program 110 is able to interact with other programs. By way of an example and not a limitation, the program 110 may cooperate with, or be integrated to, another program, such as a product purchasing program. In one embodiment, the appropriate product may be ordered, for example, over the world-wide-web. In another embodiment, the program 110 is loaded onto a computer, such as a desktop or laptop computer.

As depicted in FIG. 15, one embodiment, of the program 110 is depicted. A shown therein, the acquisition routine 112 obtains data through the application subroutine 113. Here, the user inputs whether the application is a “Tangent Application” or a “Deadend Application.”

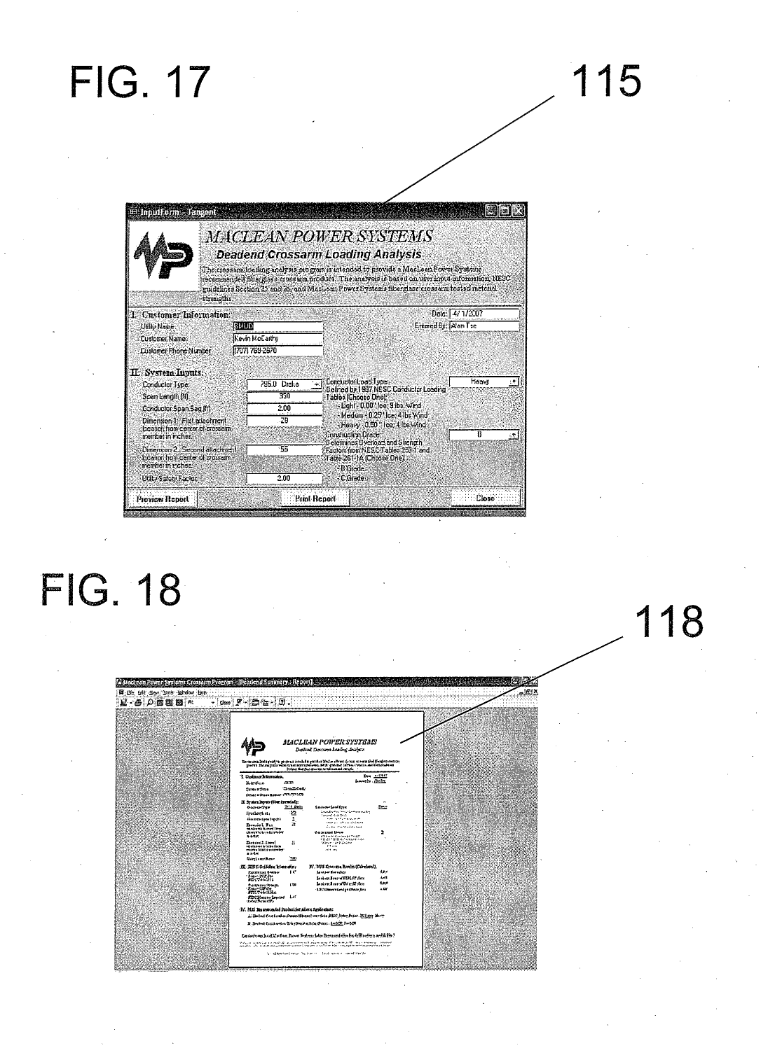

Referring now to FIG. 16, one embodiment of the user interface of the data subroutine 114 is shown. FIG. 16 depicts the data subroutine 114 for a “Tangent Application,” wherein the user inputs the conductor type, the span length, the dimensions for pin holes, the utility safety factor, the conductor load type (such as the NESC conductor load type), and the construction grade (such as the NESC construction grade). FIG. 17 depicts the data subroutine 114 for a “Deadend Application,” wherein the user inputs the conductor type, the span length, the conductor span sag, the dimensions for pin_holes, the utility safety factor, the conductor load type (such as the NESC conductor load type), and the construction grade (such as the NESC construction grade).

Referring now to FIG. 10, after the calculation routine 115 calculates the plurality of loads for either the “Tangent Application” or the “Deadend Application,” the report routine 116 determines if product is available to support the user's requirements by the product available 117 search. If product is available that supports the user's requirements, the report generation 118 of the program 110 generates a report of the available products for the user. One embodiment, of the report is depicted in FIG. 18.

What is claimed is:

1. A cross arm assembly comprising:
a) a first composite member provided with a first outer surface and second outer surface, the first composite member includes a fiber;
b) a second composite member provided with a first outer surface and second outer surface, the second composite member including a fiber;
c) a first hardware plate provided an internal surface, a first projection, and second projection;
d) a second hardware plate provided with an internal surface, a first projection, and a second projection;
e) the first outer surface of the first composite member and the first outer surface of the second composite member engage the internal surface of the first hardware plate;
f) the second outer surface of the first composite member and the second outer surface of the second composite member engage the internal surface of the second hardware plate; and
g) a pole mount provided with a plurality of clamp holes, wherein the pole mount can be moved up or down

2. A method for selecting a product, the method comprising the steps of:
a) running an acquisition routine;
b) running an application subroutine provided with prompting a user to select a type of cross-arm application;
c) running a data subroutine;
d) running a calculation routine; and
e) running a report routine, wherein the report routine provides the user with a cross arm type.

3. The method as defined in claim 2 wherein the data subroutine comprises the steps of:
i) obtaining a span length;
ii) obtaining a dimension for a top pin hole;
iii) obtaining a utility safety function;
iv) obtaining a conductor load type; and
v) obtaining a construction grade.

4. The method as defined in claim 2 wherein the data subroutine comprises the steps of:
i) obtaining a span length;
ii) obtaining a conductor span sag;
iii) obtaining a dimension for a top pinhole;
iv) obtaining a utility safety factor;
v) obtaining a conductor load type; and
vi) obtaining a construction grade.
